(19) United States
(12) Patent Application Publication
(10) Pub. No.: US 2007/0210571 A1
(43) Pub. Date: Sep. 13, 2007

(54) Memorabilia and keepsake protective foam cushion

(75) Inventor: Suzanne Margaret Gill, Pocatello, ID (US)

Correspondence Address: Suzanne Gill, 153 Fredregill Rd., Pocatello, ID, 83204, US

(73) Assignee: Suzanne M. Gill, Pocatello, ID (US)

(21) Appl. No.: 11/360,195

(22) Filed: Feb. 23, 2006

(51) Int. Cl. B42D 3/00

(52) U.S. Cl. 281/29; 40/797

(57) ABSTRACT

A memorabilia scrapbook page protector that is adaptive, easy to use, functional and inexpensive. The invention provides an easy to use solution for all types of new or existing memorabilia scrapbook pages. The invention has only two parts, held together by thermal fusion, adhesive or thread. The main part is a piece of pre-sized foam sheet that forms the protective barrier used to safeguard each page from damage due to raised page element interaction. Part two consists of a header constructed of paper, cloth, plastic or felt which is used to attach the foam sheet to the memorabilia scrapbook page using thermal fusion, adhesive, stitching or fasteners.

### FIELD OF THE INVENTION

The present invention relates to . . . Memorabilia, photograph protection and, more particularly, to . . . Scrabooking and Keepsakes

### BACKGROUND OF THE INVENTION

Due to the introduction of raised, sharp, protruding scrapbook/keepsake page elements, it has become necessary to provide for the protection of paper element pages, photographs and general keepsake memorabilia to prevent damage caused by the use of such page elements in scrapbook memorabilia page layouts. Since the page elements are placed into a binder or album, the pages are generally opposed to one another and come into close contact, with damaging results, due to opposing page element interaction. As a consequence, page elements can cause irreparable damage to photographs, keepsakes, paper product pages as well as any other damageable items placed into keepsake album pages.

The first solution exists in the form of a thin film plastic sleeve type page protector.

The second solution provided to date is the use of a vacuum formed plastic protector use to encapsulate the keepsake page within two opposing vacuum formed sheets of plastic.

The shortcomings of the thin film plastic page protector is that it provides no protection for raised element memorabilia scrapbook pages and photographs due to the extremely thin plastic film. The plastic is easily damaged and the damage is subsequently transferred through the plastic into the elements and photographs of the scrapbook page itself.

The shortcomings of the vacuum formed solution is that it is both expensive and cumbersome. The product only allows for a fixed size and thickness of keepsake page and is inflexible to any change from it's current configuration due to the rigid vacuum formed design. Thickness is limited to the protection of pages not more than one quarter of an inch thick, and page size is fixed at 12″ by 12″.

It is therefore an object of the invention to provide for a simple memorabilia page protector.

It is another object of the invention to provide an adaptable memorabilia page protector.

It is another object of the invention to provide for an easy to use memorabilia page protector.

It is another object of the invention to provide for an inexpensive memorabilia page protector.

### SUMMARY OF THE INVENTION

In accordance with the present invention, there is provided a memorabilia-keepsake page protector that is adaptive, easy to use, functional and inexpensive. The invention is simple, provides an easy to use solution for all types of new or existing size and thickness memorabilia scrapbook pages. The invention has only two parts, held together by either an adhesive, thread or staples. The main component is a piece of pre-sized foam cushioning sheet that forms a protective barrier used to safeguard each page from damage, due to raised page element interaction, between pages placed into an album or any other type of binding medium. Part two consists of a header constructed of paper, cloth, plastic, or felt used to attach the foam to the memorabilia scrapbook page. The header is affixed to the foam through the use of thermal fusion, an adhesive, sewing through the header and foam or by the use of staples to affix the header to the foam. The finished unit's header is then attached to the back of memorabilia page using an adhesive, stitching or fasteners. The header is then attached to the back of the page with the foam covering the face of each page. The units can be combined or layered as needed to provide each memorabilia page with the desired level of protection. The foam will protect each page's elements from damage by forming a cushion, keeping the page elements from coming in contact with each other. Each unit can also be cut to any desired finished size or shape, using common scissors.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of an an assembled memorabilia scrapbook page protector assembly in accordance with the invention;

FIG. 2 is a side perspective view of an a side perspective cross section of the invention prior to assembly;

FIG. 3 is a perspective view of an a perspective view of the invention in use within a scrapbook album;

FIG. 4 is a perspective bottom view of an a bottom perspective view of the header attachment in accordance with the invention; and

FIG. 5 is a rear perspective view of a protective foam sheet and plastic header assembled in accordance with the invention using thermal fusion.

For purposes of clarity and brevity, like elements and components will bear the same designations and numbering throughout the FIGURES.

### DESCRIPTION OF THE PREFERRED EMBODIMENT

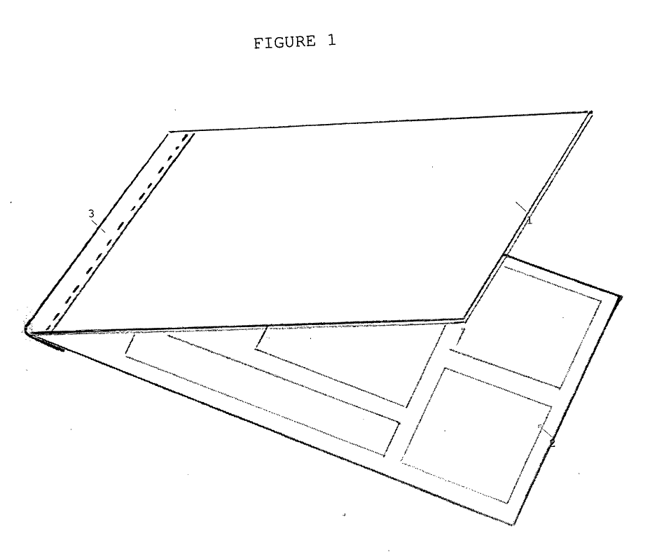

FIG. 1 is a perspective view of the invention assembled in accordance with the invention. The header is used to attach the protective foam sheet 1 to the scrapbook page 2. The header is attached to the foam sheet using stitched thread, glue or a staple. The header is attached to the back of the scrapbook using glue, tape or stitching.

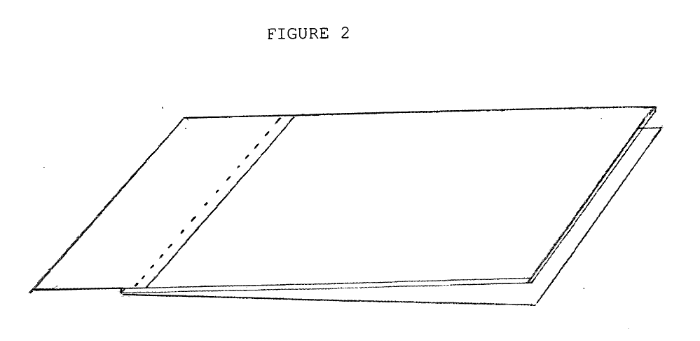

FIG. 2 is side perspective cross section showing each element of the invention before final assembly. The header is stitched or glued atop the foam sheet and is then positioned over the scrapbook page 2 prior to attaching the header to the back of the scrapbook page 2.

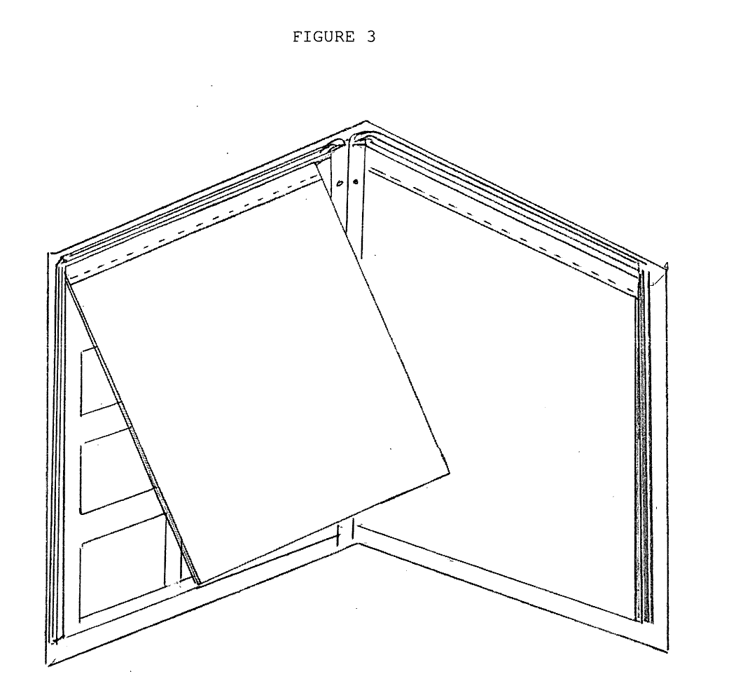

FIG. 3 is a perspective view of the assembled invention used within a scrapbook album 4. The protective foam sheet 1 can be lifted to view the protected page underneath.

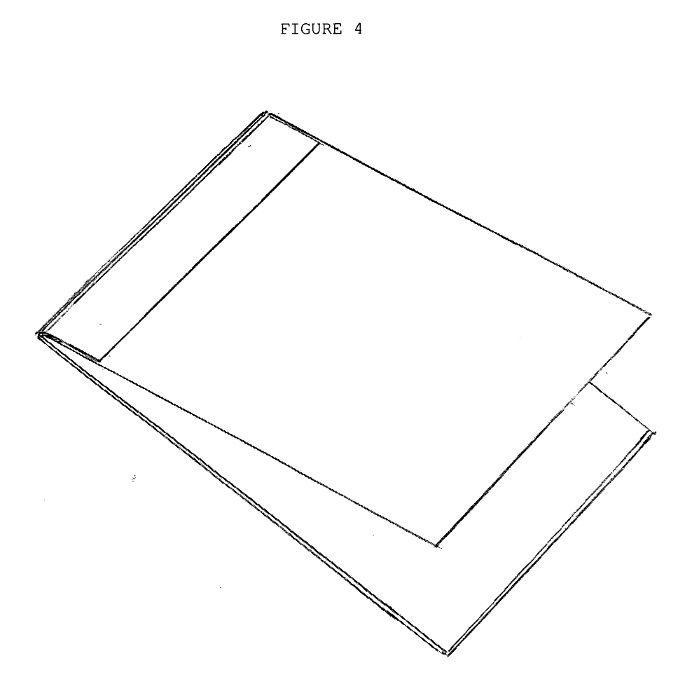

FIG. 4 is a bottom perspective view of the assembled invention showing the attachment header 3 attached to the back of the scrapbook page 2.

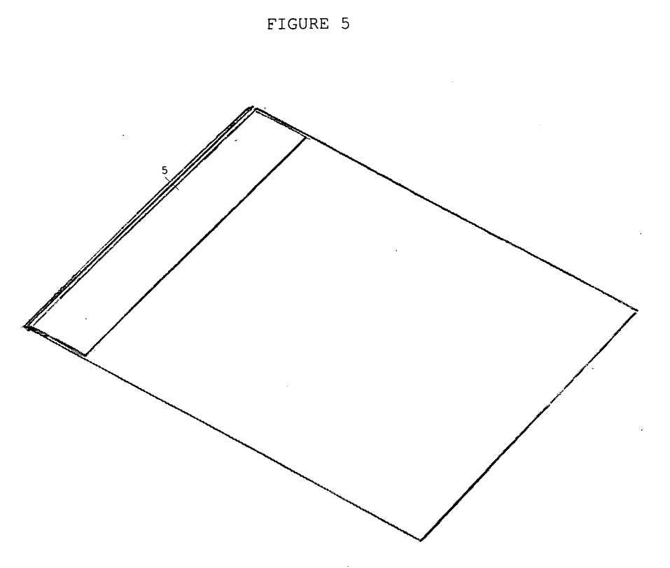

FIG. 5 is a rear perspective view of the assembled invention showing the fused plastic attachment header 5 attached to the back of the foam using thermal fusion. Both the foam and header are fused together using a heat sealing machine which bonds the two layers together permanently. The cohesive bond formed allows the two materials to form a single seamless piece. The thermal bond is formed across the entire upper edge shown in the upper left of the drawing. This leaves a flap behind the foam that can then be attached to the back of the scrapbooking memorabilia page.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A memorabilia and keepsake protective foam cushion for the protection of photos and memorabilia from punctures, damaging pressure dents and scratches comprising:
means for a protective cushion;
means for attaching the foam to the scrapbook page, securely adhered to said means for a protective cushion; and
means for attaching the foam to the memorabilia scrapbook page, thermally fused to said means for a protective cushion.

2. The memorabilia and keepsake protective foam cushion in accordance with claim 1, wherein said means for a protective cushion comprises a protective foam sheet.

3. The memorabilia and keepsake protective foam cushion in accordance with claim 1, wherein said means for attaching the foam to the scrapbook page, comprises a paper, plastic, felt, cloth attachment header.

4. The memorabilia and keepsake protective foam cushion in accordance with claim 1, wherein said means for attaching the foam to the memorabilia scrapbook page comprises a fused plastic attachment header.

5. A memorabilia and keepsake protective foam cushion for the protection of photos and memorabilia from punctures, damaging pressure dents and scratches comprising:
a protective foam sheet, for a protective cushion;
a paper, plastic, felt, cloth attachment header, for attaching the foam to the scrapbook page, securely adhered to said protective foam sheet; and
a fused plastic attachment header, for attaching the foam to the memorabilia scrapbook page, thermally fused to said protective foam sheet.

6. A memorabilia and keepsake protective foam cushion for the protection of photos and memorabilia from punctures, damaging pressure dents and scratches comprising:
a protective foam sheet, for a protective cushion;
a paper, plastic, felt, cloth attachment header, for attaching the foam to the scrapbook page, securely adhered to said protective foam sheet; and
a fused plastic attachment header, for attaching the foam to the memorabilia scrapbook page, thermally fused to said protective foam sheet.
